(19) United States
(12) Patent Application Publication
(10) Pub. No.: US 2021/0318200 A1
(43) Pub. Date: Oct. 14, 2021

(54) EVALUATING THE QUANTITY OF FLUID LOST IN A DISTRIBUTION

(71) Applicant: SAGEMCOM ENERGY & TELECOM SAS, Rueil Malmaison (FR)

(72) Inventor: Henri TEBOULLE, RUEIL MALMAISON (FR)

(21) Appl. No.: 17/228,487

(22) Filed: Apr. 12, 2021

(30) Foreign Application Priority Data
Apr. 14, 2020 (FR) 2003699

(51) Int. Cl. G01M 3/28; F17D 5/02

(52) U.S. Cl. CPC G01M 3/2807; F17D 5/02

(57) ABSTRACT

A method of evaluating the quantity of fluid that is lost in a fluid distribution network includes steps of: for each time interval of a given measurement period, acquiring a main measurement taken by the main fluid meter and representative of the quantity of fluid distributed via the main pipe during said time interval, and, for each secondary fluid meter, acquiring a secondary measurement taken by said secondary fluid meter and representative of the quantity of fluid that is distributed during said time interval via the secondary pipe to which said secondary fluid meter is connected; calculating a measurement difference equal to the difference between the main measurement and the sum of the secondary measurements; determining a minimum value of the measurement differences over the given measurement period; and evaluating the quantity of fluid lost over the given measurement period on the basis of the minimum value.

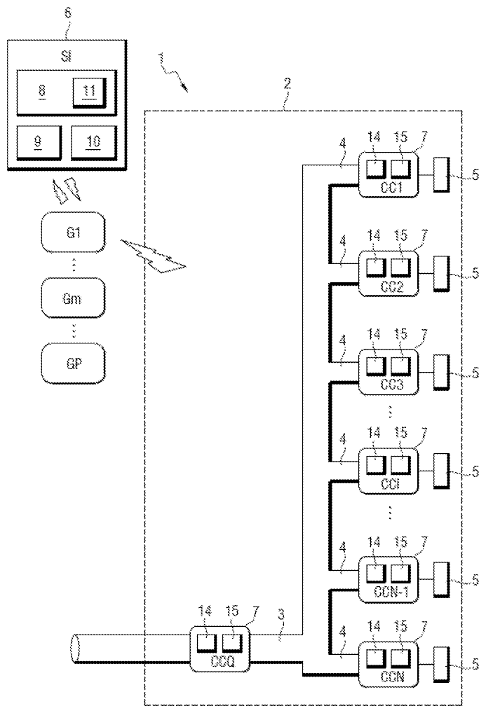

The invention relates to the field of fluid distribution networks that include smart meters.

### BACKGROUND OF THE INVENTION

A modern water meter, also known as a “smart” water meter, naturally includes a measuring device for measuring the water consumption of an installation, and it also includes a processor module and a communication module.

The processor module enables the water meter to perform a certain number of functions, and in particular to analyze various kinds of data, e.g. relating to the water consumption of the installation, to the billing of the customer, to the state of the water distribution network, or indeed to the operation of the water meter itself.

The communication module enables the water meters to communicate with an information system (IS) of the network manager, possibly via a data concentrator, a gateway, or indeed another meter (such as a district smart meter). The communication module may perform any type of communication, and for example communication via a cellular network of 2G, 3G, 4G, Cat-M, or NB-IoT type, communication using the long range (LoRa) protocol, radio communication using the Wize standard operating at the frequency of 169 megahertz (MHz), etc.

It is important to be able to evaluate the quantity of water that is lost in a water distribution network, in order to be able to detect and locate a leak whenever this quality of lost water is abnormally high.

Several methods have been envisaged for evaluating the quality of water that is lost in a water distribution network, but none of them gives full satisfaction.

One of those methods consists in relying on an indicator equal to the ratio between the volume of water that has been distributed and the volume of water that has been consumed as measured by the various water meters of the network. However, that method cannot distinguish between losses of water due to leaks proper, and legitimate unmetered water consumption being drawn by public services (fire brigade, swimming pools, etc.), or even thefts of water (which, even though they may be problematic, do not require urgent action to repair an element of the water distribution network).

### OBJECT OF THE INVENTION

An object of the invention is to evaluate accurately the quantity of fluid that is lost in a fluid distribution network.

### SUMMARY OF THE INVENTION

In order to achieve this object, there is provided an evaluation method for evaluating the quantity of fluid that is lost in a fluid distribution network that comprises a main pipe to which a main fluid meter is connected, and secondary pipes depending from the main pipe and to which secondary fluid meters are connected, the evaluation method comprising the following steps that are repeated over successive measurement periods, themselves subdivided into time intervals:
for each time interval of a given measurement period, acquiring a main measurement taken by the main fluid meter and representative of the quantity of fluid distributed via the main pipe during said time interval, and, for each secondary fluid meter, acquiring a secondary measurement taken by said secondary fluid meter and representative of the quantity of fluid that is distributed during said time interval via the secondary pipe to which said secondary fluid meter is connected;
for each time interval of the given measurement period, calculating a measurement difference equal to the difference between the main measurement and the sum of the secondary measurements;
determining a minimum value of the measurement differences over the given measurement period;
evaluating the quantity of fluid lost over the given measurement period on the basis of the minimum value.

The minimum value of the measurement differences is a very accurate estimate of the quantity of fluid that is lost in the fluid distribution network over a duration equal to the duration of one time interval. The method of the invention makes it possible of this estimate to exclude unmetered fluid consumption that has been drawn off legitimately and also fluid consumption that has been stolen.

There is also provided a method as described above, wherein the quantity of fluid that is lost over the given measurement period is evaluated as being equal to the minimum value multiplied by the number of time intervals contained in the given measurement period.

There is also provided a method as described above, wherein, for each secondary fluid meter, a first secondary measurement representative of the quantity of fluid that is distributed during the first time interval of the given measurement period via the secondary pipe to which said secondary fluid meter is connected is evaluated by using the following formula:

Δi_{j_0}=Ciⱼ₊₁−(Ciⱼ+Σₖ₌₁^{k=K-1}Δi_{j_k}) where:
j is the given measurement period;
K is the number of time intervals in each measurement period;
Δi_{j_0} is the first secondary measurement;
Cᵢⱼ is a total secondary measurement representative of the total quantity of fluid distributed via the secondary pipe to which said secondary fluid meter is connected up to the beginning of the given measurement period;
Ciⱼ₊₁ is a total secondary measurement representative of the total quantity of fluid distributed via the secondary pipe to which said secondary fluid meter is connected up to the beginning of the measurement period following the given measurement period;
Δi_{j_k} are the secondary measurements for the time intervals of the given measurement period following the first time interval.

There is also provided a method as described above, wherein, for the main fluid meter, a first main measurement representative of the quantity of fluid distributed via the main pipe during the first time interval of the given measurement period is evaluated by using the following formula:

ΔCCQ_{j_0}=CQⱼ₊₁−(CQⱼ+Σₖ₌₁^{k=K-1}ΔCCQ_{j_k}) where:
j is the given measurement period;
K is the number of time intervals in each measurement period;
ΔCCQ_{j_0} is the first main measurement;
CQⱼ is a total main measurement representative of the total quantity of fluid distributed via the main pipe up to the beginning of the given measurement period;
CQⱼ₊₁ is a total main measurement representative of the total quantity of fluid distributed via the main pipe up to the beginning of the measurement period following the given measurement period;
ΔCCQ_{j_k} are the main measurements for the time intervals of the given measurement period following the first time interval.

There is also provided a method as described above, wherein each measurement period has a duration of one day, and wherein each time interval has a duration of one hour.

There is also provided a method as described above, the main fluid meter and the secondary fluid meters being water meters.

There is also provided a device comprising both a communication module arranged to receive the main measurements taken by the main fluid meter and the secondary measurements taken by the secondary fluid meters, and also a processor module arranged to perform the above-described method.

There is also provided a device as described above, the device being an information system or a gateway or a data concentrator or a district smart fluid meter.

There is also provided a computer program including instructions for causing the above-described device to execute the steps of the above-described method.

There is also provided a computer readable storage medium, on which the above-described computer program is stored.

The invention can be better understood in the light of the following description of a particular, nonlimiting embodiment of the invention.

### BRIEF DESCRIPTION OF THE DRAWING

Reference is made to the sole FIGURE of the accompanying drawing:

The FIGURE shows a water distribution network in which the invention is implemented.

### DETAILED DESCRIPTION OF THE INVENTION

With reference to the FIGURE, the method of the invention for evaluating a quantity of fluid lost in a fluid distribution network is implemented in this example in a water distribution network 1 for supplying water to a “district” 2, i.e. to a geographical area having a plurality of water installations, each situated by way of example in a dwelling, in a restaurant, in a shop, etc.

The water distribution network 1 has a main pipe 3 and secondary pipes 4, each connected to a respective different water installation 5.

The water distribution network 1 also has an information system (IS) 6 of the water distribution network manager, gateways Gm, and ultrasonic water meters 7.

The IS 6 has an application server 8, a long-range (LoRa) network server (LNS) 9, and a first communication module 10.

The application server 8 comprises a first processor module 11 comprising at least a first processor component adapted to execute instructions of a program for performing certain steps of the evaluation method described below. By way of example, the first processor component may be a processor, a microcontroller, or indeed a programmable logic circuit such as a field programmable gate array (FPGA) or an application-specific integrated circuit (ASIC).

The LNS server 9 serves in particular to manage communications with all of the gateways Gm and with all of the water meters 7 to which the LNS server 9 is connected. The LNS server 9 communicates with the gateways Gm directly, and with the water meters 7 via the gateways Gm. In order to communicate with the gateways Gm, the LNS server 9 uses the first communication module 10, which in this example serves to perform radio communication transporting frames of the LoRa protocol.

The gateways Gm are LoRa gateways. The variable m lies in the range 1 to P.

Each gateway Gm includes a communication module enabling it to communicate with the LNS server 9 by radio communication transporting frames of the LoRa protocol, and with the water meters 7 by radio communication using the LoRa protocol.

All of the communication between the IS 6 and the water meters 7, whether uplink or downlink, passes via the gateways Gm.

The water meters 7 comprise a main water meter CCQ, which is a smart meter for the district, and a plurality of secondary water meters CCi, which are respective smart meters for consumers.

The main water meter CCQ is connected to the main pipe 3. A different secondary water meter CCi is connected to each secondary pipe 4. The variable i varies over the range 1 to N, where N is the number of secondary pipes 4 and is thus the number of secondary water meters CCi.

The secondary pipes 4 depend from the main pipe 3, i.e. they are all connected to the main pipe 3 downstream from the main water meter CCQ: downstream from the main water meter CCQ, the main pipe 3 divides into a bundle formed by the secondary pipes 4.

In this example, the term “upstream” means on the side of the water distribution network, and the term “downstream” means on the side of the water installations 5.

Each water meter 7 includes a second communication module 14 enabling it to communicate by radio communication, making use of the LoRa protocol. Each water meter 7 also includes a second processor module 15 comprising at least one second processor component adapted to execute instructions of a program. By way of example, the second processor component may be a processor, a microcontroller, or indeed a programmable logic circuit such as an FPGA or an ASIC.

The method of invention seeks to evaluate the quantity of water lost in a water distribution network 1 between the main water meter CCQ and the secondary water meters CCi, i.e. in the region of the water distribution network 1 that is situated downstream from the main water meter CCQ and upstream from each of the secondary water meters CCi.

The method comprises a certain number of steps, which are repeated over successive measurement periods, each subdivided into time intervals. In this example, a measurement period has a duration of one day (and begins at midnight), and each time interval has a duration of one hour. Each measurement period thus comprises 24 time intervals.

For each time interval of a given measurement period j, i.e. for each hour of a given day j, and for each secondary water meter CCi, the first processor module 11 of the application server 8 of the IS 6 acquires a secondary measurement taken by said secondary water meter CCi that is representative of a quantity of water distributed during said time interval via the secondary pipe 4 to which said secondary water meter CCi is connected. The secondary measurements are transmitted by the second communication module 14 of the secondary water meter CCi to the first communication module 10 of the IS 6 via one of the gateways Gm.

These secondary measurements are included in a load curve, referenced Chi, that the first processor module 11 receives every day, several times a day, from each secondary water meter CCi. The load curve Chi is made up of a reference index written Ciⱼ, and of successive index differences, referred to as “deltas”, Δi_{j_1} to Δi_{j_23}.

Each index delta Δi_{j_k} is a secondary measurement taken by the secondary water meter CCi for a given day j. This secondary measurement is representative of the quantity of water that is distributed during the (k+1)^{th} time interval to the secondary installation 5 that is connected to the secondary pipe 4, as measured by said secondary water meter CCi connected to said secondary pipe 4. In this example, the secondary measurements are volumes of water (expressed as xxx,xxx cubic meters (m³)).

Thus, by way of example, between 2 AM and 3 AM, i.e. during the third time interval of the given day j, the secondary water meter CCi measures that a quantity of water equal to Δi_{j_2} was distributed via the secondary pipe 4 to which it is connected.

The reference index Ciⱼ is a total secondary measurement representative of the total quantity of water that has been distributed via the secondary pipe 4 to which the secondary water meter CCi is connected up to the beginning of the given day j.

For the following day j+1 that follows the given day j, and for each secondary water meter CCi, the first processor module 11 also acquires the total secondary measurement representative of the quantity of water that has been distributed via the secondary pipe 4 to which the secondary water meter CCi is connected up to the beginning of the day j+1 following the given day j.

For each time interval of the given day j, the first processor module 11 also acquires a load curve ChQ that is made out of a reference index written CQⱼ, and of successive index deltas written ΔCCQ_{j_1} to ΔCCQ_{j_23}.

Each index delta ΔCCQ_{j_k} is a main measurement taken by the main water meter CCQ. This main measurement is representative of the quantity of water that is distributed during the (k+1)^{th} time interval via the main pipe 3. The main measurements are volumes of water (expressed as xxx,xxx m³). The main measurements are transmitted by the second communication module 14 of the main water meter CCQ to the first communication module 10 of the IS 6 via one of the gateways Gm.

The reference index CQⱼ is a total main measurement representative of the total quantity of water that has been distributed via the main pipe 3 up to the beginning of the given day j.

For the following day j+1 that follows the given day j, the first processor module 11 also acquires the total main measurement CQⱼ₊₁ representative of the quantity of water that has been distributed via the main pipe 3 up to the beginning of the day j+1 following the given day j.

It should be observed that for each secondary water meter CCi, the first processor module 11 does not receive directly the first secondary measurement representative of the quantity of water distributed via the secondary pipe 4 to which secondary water meter CCi is connected during the first time interval of the given measurement period (i.e. between midnight and 1 AM of the given day j).

This first secondary measurement Δi_{j_0} is evaluated using the following formula: Δi_{j_0}=Ciⱼ₊₁−(Ciⱼ+Σₖ₌₁^{k=K-1}Δi_{j_k}) where:
K is the number of time intervals in each measurement period (in this example, K=24);
Δi_{j_0} is the first secondary measurement;
Ciⱼ is the total secondary measurement representative of the total quantity of water distributed via the secondary pipe 4 to which the secondary water meter CCi is connected up to the beginning of the given measurement period (i.e. the given day j);
Ciⱼ₊₁ is the total secondary measurement representative of the total quantity of water distributed via the secondary pipe 4 to which said secondary water meter CCi is connected up to the beginning of the measurement period following the given measurement period (i.e. the day j+1);
Δi_{j_k} are the secondary measurements for the time intervals of the given measurement period following the first time interval.

Likewise, the first processor module 11 does not receive directly the first main measurement representative of the quantity of water distributed via the main pipe 3 during the first time interval of the given measurement period.

The first main measurement is evaluated using the following formula: ΔCCQ_{j_0}=CQⱼ₊₁−(CQⱼ+Σₖ₌₁^{k=K-1}ΔCCQ_{j_k}) where:
K is the number of time intervals in each measurement period (in this example, K=24);
ΔCCQ_{j_0} is the first main measurement;
CQⱼ is a total main measurement representative of the total quantity of water distributed via the main pipe up to the beginning of the given measurement period;
CQⱼ₊₁ is a total main measurement representative of the total quantity of water distributed via the main pipe up to the beginning of the measurement period following the given measurement period;
ΔCCQ_{j_k} are the main measurements for the time intervals of the given measurement period following the first time interval.

For each time interval of the given measurement period, the first processor module 11 then calculates a measurement difference equal to the difference between the main measurement (taken by the main water meter) and the sum of the secondary measurements (each taken by one of the secondary water meters).

Thereafter, the first processor module 11 determines the minimum value of the measurement differences over the measurement period.

For the given day j, the minimum value of the measurement differences is thus equal to:

VP=Min_{k=0àk=K-1}(ΔCCQ_{j_k}−Σᵢ₌₁^{i=N}Δi_{j_k})

It should be recalled that N is the number of secondary water meters CCi that are “connected” to the main water meter CCQ.

It is considered that in the event of a leak, water is lost continuously. On the basis of the minimum value, the first processor module 11 evaluates the quantity of water that has been lost over the given measurement period, i.e. the daily volume of water that is lost.

The quantity of water that is lost over the given measurement period is equal to the minimum value multiplied by the number of time intervals contained in the given measurement period.

Thus:

VQ=K·VP, i.e. for K=24, VQ=24·VP

where VQ is the quantity of water that is lost over the given measurement period, i.e. over the given day j, and where VP is the minimum value of the measurement differences.

The first processor module 11 thus determines the daily volume of water lost in the district 2 of the main water meter CCQ.

The minimum value of the measurement differences, which is typically obtained during the night, is a very accurate estimate of the quantity of water that is lost over a duration equal to the duration of a time interval.

Specifically, since a water leak is a phenomenon that is long lasting and continuous, and since the flow rate is substantially constant, it is known that the quantities of water that are detected as being greater than the minimum value corresponding either to unmetered water consumption being drawn off legitimately (typically by public services), or else to water being stolen. Taking account of the minimum value of the measurement differences thus makes it possible to eliminate from the estimate any unmetered water consumption that has been drawn off legitimately or that has been or stolen.

The first processor module 11 then compares the daily volume of water loss with a predetermined threshold VS. In this example, the predetermined threshold VS is a threshold that can be set.

A limited amount of water loss is a phenomenon that is normal and commonplace in a water distribution network. In general, a water distribution network is observed to have a “nominal” rate of water loss lying in the range 5% to 10% of the water distributed.

Nevertheless, if the daily volume of water loss is greater than the predetermined threshold, the first processor module 11 detects that the loss of water is abnormal and that this loss of water might correspond to a water leak that is large and problematic. The first processor module 11 produces an alarm message to schedule action for repairing the damaged element of the network from which the leak originates.

Naturally, the invention is not limited to the embodiment described, but covers any variant coming within the ambit of the invention as defined by the claims.

The method of the invention could be implemented in full or in part in a device other than the IS, and for example in a gateway, in a data concentrator, in a district smart meter, etc.

The measurement periods need not necessarily be days, at the time intervals need not necessarily be hours.

Communications between the meters, the gateways, and the IS could be performed using any type of communication technology and any type of protocol.

The invention may be implemented in a network for distributing a fluid other than water: gas, oil, etc.

1. An evaluation method for evaluating the quantity of fluid that is lost in a fluid distribution network that comprises a main pipe to which a main fluid meter is connected, and secondary pipes depending from the main pipe and to which secondary fluid meters are connected, the evaluation method comprising the following steps that are repeated over successive measurement periods, themselves subdivided into time intervals:
for each time interval of a given measurement period, acquiring a main measurement taken by the main fluid meter and representative of a quantity of fluid distributed via the main pipe during said time interval, and, for each secondary fluid meter, acquiring a secondary measurement taken by said secondary fluid meter and representative of a quantity of fluid that is distributed during said time interval via the secondary pipe to which said secondary fluid meter is connected;
for each time interval of the given measurement period, calculating a measurement difference equal to a difference between the main measurement and the sum of the secondary measurements;
determining a minimum value of the measurement differences over the given measurement period;
evaluating the quantity of fluid lost over the given measurement period on the basis of the minimum value.

2. The evaluation method according to claim 1, wherein the quantity of fluid that is lost over the given measurement period is evaluated as being equal to the minimum value multiplied by the number of time intervals contained in the given measurement period.

3. The evaluation method according to claim 1, wherein, for each secondary fluid meter, a first secondary measurement representative of a quantity of fluid that is distributed during the first time interval of the given measurement period via the secondary pipe to which said secondary fluid meter is connected is evaluated by using the following formula:
Δi_{j_0}=Ciⱼ₊₁−(Ciⱼ+Σₖ₌₁^{k=K-1}Δi_{j_k}) where:
j is the given measurement period;
K is the number of time intervals in each measurement period;
Δi_{j_0} is the first secondary measurement;
Ciⱼ is a total secondary measurement representative of the total quantity of fluid distributed via the secondary pipe to which said secondary fluid meter is connected up to the beginning of the given measurement period;
Ciⱼ₊₁ is a total secondary measurement representative of the total quantity of fluid distributed via the secondary pipe to which said secondary fluid meter is connected up to the beginning of the measurement period following the given measurement period;
Δi_{j_k} are the secondary measurements for the time intervals of the given measurement period following the first time interval.

4. The evaluation method according to claim 1, wherein, for the main fluid meter, a first main measurement representative of a quantity of fluid distributed via the main pipe during the first time interval of the given measurement period is evaluated by using the following formula:
ΔCCQ_{j_0}=CQⱼ₊₁−(CQⱼ+Σₖ₌₁^{k=K-1}ΔCCQ_{j_k}) where:
j is the given measurement period;
K is the number of time intervals in each measurement period;
ΔCCQ_{j_0} is the first main measurement;
CQⱼ is a total main measurement representative of the total quantity of fluid distributed via the main pipe up to the beginning of the given measurement period;
CQⱼ₊₁ is a total main measurement representative of the total quantity of fluid distributed via the main pipe up to the beginning of the measurement period following the given measurement period;
ΔCCQ_{j_k} are the main measurements for the time intervals of the given measurement period following the first time interval.

5. The evaluation method according to claim 1, wherein each measurement period has a duration of one day, and wherein each time interval has a duration of one hour.

6. The evaluation method according to claim 1, wherein the main fluid meter and the secondary fluid meters are water meters.

7. A device comprising both a communication module arranged to receive the main measurements taken by the main fluid meter and the secondary measurements taken by the secondary fluid meters, and also a processor module arranged to perform the evaluation method according to claim 1.

8. The device according to claim 7, wherein the device is an information system or a gateway or a data concentrator or a district smart fluid meter.

9. A computer program including instructions for causing a device comprising both a communication module arranged to receive the main measurements taken by the main fluid meter and the secondary measurements taken by the secondary fluid meters, and also a processor module arranged to to execute the steps of the method according to claim 1.

10. A computer readable storage medium having stored thereon the computer program according to claim 9.
